(19) United States
(12) Patent Application Publication
(10) Pub. No.: US 2006/0095841 A1
(43) Pub. Date: May 4, 2006

(54) Methods and apparatus for document management

(75) Inventor: Robert Y. Oikawa, Redmond, WA (US)

Correspondence Address: Randy J. Pritzker;Wolf, Greenfield & Sacks, P.C., 600 Atlantic Avenue, Boston, MA, 02210-2206, US

(73) Assignee: Microsoft Corporation, Redmond, WA (US)

(21) Appl. No.: 10/975,911

(22) Filed: Oct. 28, 2004

(51) Int. Cl. G06F 17/24; G06F 17/21

(52) U.S. Cl. 715/531

(57) ABSTRACT

One embodiment of the invention is directed to the analysis of a document. The document may be retrieved and automatically analyzed to measure quality metrics defined for the document. A quality metric is any attribute of the document and may be, for example, a word count, a sentence count, a paragraph count, or any other suitable attribute. A set of results based on the act of analyzing the document may be generated and stored and a report based, at least in part, on the set of results that indicates measurements of the quality metrics over a period of time.

### FIELD OF THE INVENTION

The present invention relates to the tracking of documents.

### DESCRIPTION OF THE RELATED ART

Development of large-scale, multi-component systems may be highly complex and may require a high degree of project management and design expertise. Consequently, project management of such systems typically involves creation of a number of project documents that aid in project planning and system design. Harsh deadlines for completion of system components, however, often causes the documentation to be neglected, resulting in incomplete or low-quality documentation. This may result in lapses in communication, incomplete or inconsistent implementation of systems, and lower product quality. Thus, it is desirable to maintain high quality and complete project documentation.

### SUMMARY OF THE INVENTION

One illustrative embodiment is directed to a method comprising acts of: retrieving a document; automatically analyzing the document to measure at least one quality metric; generating a set of results based on the act of analyzing the document; storing the set of results; and generating a report based, at least in part, on the set of results that indicates measurements of the at least one quality metric over a period of time. Another embodiment of the invention is directed to at least one computer readable medium encoded with instructions that, when executed on a computer system, perform the above-described method.

The summary provided above is intended to provide a basic understanding of the disclosure to the reader. This summary is not an exhaustive or limiting overview of the disclosure and does not define or limit the scope of the invention in any way. The invention is limited only as defined by the claims and the equivalents thereto

### BRIEF DESCRIPTION OF THE DRAWINGS

FIG. 1 is a flowchart illustrating a process for evaluating a document, in accordance with one embodiment of the invention; and

FIG. 2 is a diagram illustrating an example of report that may be generated in accordance with one embodiment of the invention.

### DETAILED DESCRIPTION

One embodiment of the invention is directed to automatically analyzing an electronic document to evaluate the quality of the document. For example, project documentation for a software development project may be analyzed. The documentation may be analyzed on a regular basis and the results of the analysis may be stored. By analyzing the documentation regularly, the quality and completeness of the document may be automatically tracked over a period of time. The analysis of quality and completeness may be used to determine if progress is being made on the documentation or if the documentation is being neglected. Having an objective measure of quality and progress of completion of the documentation aids in ensuring that high quality documentation is produced in a timely fashion.

As discussed above, an electronic document may be analyzed to evaluate quality and completeness of the document. This may be done in any suitable way. For example, one or more quality metrics may be defined for the document. As used herein, a quality metric is any attribute of an electronic document that may be used to evaluate the document. Quality metrics for a document may include, for example, the number of words, number of sentences, average sentence lengths, number of paragraphs, average number of sentences per paragraph, average number of words per sentence, average number of syllables per word, number of tables, number of figures, number of embedded objects, number of spelling errors, number of grammatical errors, number of hyperlinks (e.g., world wide web links), whether such hyperlinks are working or broken, number of uses of the passive voice, and any other suitable document attribute.

Additionally, some documents may include hierarchical section headings. For example, a document may include a high-level heading for each chapter in the document and each chapter may have a number of second level subheadings that identify sections within the chapter. Further, there may be additional levels of subheadings within the second-level subheadings. Thus, in documents which include hierarchical headings, the number of headings at each heading level may also be used as a quality metric.

Another example of a quality metric is the number of words from a certain vocabulary. That is, in some documents it may be desired to avoid use of certain vocabulary words. For example, if the document is intended to be translated at a later date, it may be desirable to avoid the use of words or phrases that may not translate well into other languages. It may also be desirable to avoid other types of words or phrases and the invention is not limited to avoiding words or phrases that do not translate well. For example, it may be desirable to avoid certain words or phrases (e.g., phrases contained in a list of geo-politically incorrect terms and expressions) or any other suitable type of words or phrases. Thus, in one embodiment, a list of words or phrases that should not be used in the document may be generated and the number of words or phrases on the list that appear in the document may be used as a quality metric for the document.

In one embodiment of the invention, a document may be created from a document template. The template may identify portions of the document that are to be filled in with content using a placeholder. An example of a placeholder that may be used is “TBD,” an abbreviation for “to be done.” However, “TBD” is only one example of a placeholder, and any suitable placeholder may be used. As the document is completed, the placeholders are replaced with document content. Thus, a count of the number of placeholders may be used as a quality metric to evaluate progress in completing the document.

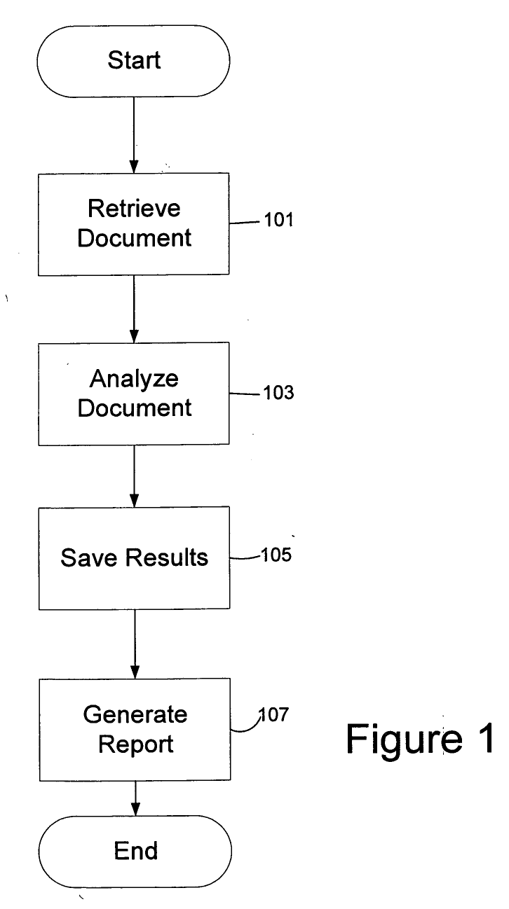

In one embodiment, an electronic document may be analyzed as shown in FIG. 1. At act 101 the document to be analyzed is retrieved. This may be done in any suitable way. For example, the document may be stored as a file at a particular location in the file system. Alternatively, the document may be stored using document management software, in a database (i.e., using a database management system), using version control software (e.g., Microsoft Visual Source Safe), or in any other suitable way. The document, or a copy of the document, may be retrieved from any such storage location.

The process next continues to act 103, wherein the document is analyzed. This may be done in any suitable way. For example, the document may be analyzed using a script that is programmed to parse the document and measure one or more quality metrics. That is, for example, the script may be programmed to count the number of words in the document, count the number of header levels, or measure any other suitable quality metric.

The process then continues to act 105, where the results of analyzing the document are saved. The results may be stored at any suitable location in any suitable way. For example, the results may be stored in a database. Additionally, the time at which the analysis of the document was performed may be stored with the results. An identifier that indicates the document from which the results were generated may also be stored with the results.

The process next continues to act 107, wherein a report of the results may be generated. That is, the results stored in act 105 may be retrieved and a report may be generated based on these results. Results stored from previous analyses of the document may also be retrieved and used in the generation of the report. For example, a report may be generated that shows how one or more quality metrics have changed over a period of time. The period of time over which the quality metric for a document is displayed may be any suitable period of time and the invention is not limited in this respect. For example, the period of time may be the period from the date of creation of the document to the time at which the last analysis of the document was performed. Alternatively, the period of time may be any other period of time, such as, for example, one week, two weeks, or a month.

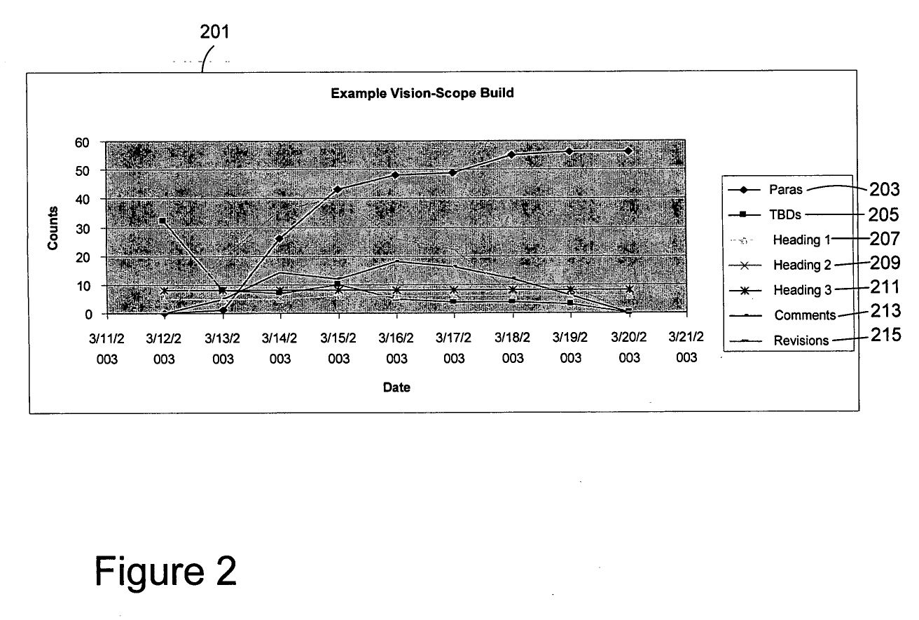

The report may be in any suitable format. An example of a report is shown in FIG. 2. In the example of FIG. 2, report 201 is a report on analysis of a vision-scope document, in the form of a line graph. The line graph shows the change in seven quality metrics over a period of time from Mar. 11, 2003 to Mar. 21, 2003. In report 201, quality metric 203 is a measure of the number of paragraphs in the document, quality metric 205 is a measure of the number of placeholders (i.e., TBDs) remaining in the document, quality metric 207 is a measure of the number of first level section headings, quality metrics 209 is a measure of the number of second level section headings, quality metric 211 is a measure of the number of third level section headings, quality metric 213 is a measure of the number of comments in the document, and quality metric 215 is a measure of the number of proposed revisions in the document. As shown in report 201, the number of paragraphs in the document has increased over the period of time, while the number of placeholders (i.e., TBDs) has decreased, indicating the progress on the document is being made.

Report 201 is in the form of the line graph, however the invention is not limited in this respect as reports may be in any suitable form. For example, a bar graph or any suitable chart or table may be used.

The process in FIG. 1 ends after the generation of the report. In one embodiment, the process may be repeated at a regular interval. For example, a daily analysis of the document may be performed and a report may be generated based on the results. It should be appreciated, however, that a daily interval is only one example of an interval that may be used and the process may be repeated at any interval. Further, the interval need not be regular, as the invention is not limited in this respect. Additionally, the analysis of the document may be performed more frequently than the generation of the report. For example, the document may be analyzed daily, while the reports based on the analyses of the document may be generated weekly.

In one embodiment of the invention, documentation related to development of a software system may be evaluated using one or more quality metrics (e.g., using the process of FIG. 1). The documentation may be, for example, documents specified by the Microsoft Solution Framework for developing software systems. Such documents include a vision-scope document, a project structure document, a requirements specification, an architectural specification, a design specification, a test plan, and other documents. When developing software systems, a build of the code is performed on a regular basis. That is, the software code is re-compiled at regular intervals so that the compiled software product incorporates all the changes made to the software code since the previous build. Thus, whenever a build of the software code is performed, the documentation associated with the software code may also be analyzed in the manner described above. This may help ensure that progress is being made on both the software code and the documentation and that the quality of the code and the documentation is not being neglected

In the example above, the documents being analyzed were documents associated with software code development. However, it should be appreciated that embodiments of the invention contemplate evaluating any type of document and the invention is not limited to use with documents associated with software code development.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention comprises at least one computer-readable medium (e.g., a computer memory, a floppy disk, a compact disk, a tape, etc.) encoded with a computer program (i.e., a plurality of instructions), which, when executed on a processor, performs the above-discussed functions of the embodiments of the present invention. The computer-readable medium can be transportable such that the program stored thereon can be loaded onto any computer environment resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

It should be appreciated that in accordance with several embodiments of the present invention wherein processes are implemented in a computer readable medium, the computer implemented processes may, during the course of their execution, receive input manually (e.g., from a user).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method comprising acts of:
retrieving a document;
automatically analyzing the document to measure at least one quality metric;
generating a set of results based on the act of analyzing the document;
storing the set of results; and
generating a report based, at least in part, on the set of results that indicates measurements of the at least one quality metric over a period of time.

2. The method of claim 1, wherein the at least quality metric includes at least one of the group comprising:
a word count, a paragraph count, a section heading count, a word count, a sentence count, a count of a words in the document that occur on a list of words to be avoided, a count of comments, a count of revisions, a count of occurrences of a predetermined placeholder, and a count of hyperlinks.

3. The method of claim 1, wherein the act of storing a set of results further comprises storing the set of results in a database.

4. The method of claim 1, wherein the document is a document associated with development of a software system.

5. The method of claim 1, wherein the act of analyzing further comprises analyzing the document over a period of time.

6. The method of claim 1, wherein the act of analyzing further comprises analyzing the document at a regular time interval.

7. The method of claim 6, wherein the regular time interval is a daily interval.

8. The method of claim 1, wherein the report is a graph.

9. The method of claim 1, wherein the act of retrieving the document comprises retrieving the document from a version control software system.

10. The method of claim 1, wherein the document was created from a document template.

11. At least one computer readable medium encoded with instructions that, when executed on a computer system, perform a method comprising acts of:
retrieving a document;
automatically analyzing the document to measure at least one quality metric;
generating a set of results based on the act of analyzing the document;
storing the set of results; and
generating a report based, at least in part, on the set of results that indicates measurements of the at least one quality metric over a period of time.

12. The at least one computer readable medium of claim 11, wherein the at least quality metric includes at least one of the group comprising:
a word count, a paragraph count, a section heading count, a word count, a sentence count, a count of a words in the document that occur on a list of words to be avoided, a count of comments, a count of revisions, a count of occurrences of a predetermined placeholder, and a count of hyperlinks.

13. The at least one computer readable medium of claim 11, wherein the act of storing a set of results further comprises storing the set of results in a database.

14. The at least one computer readable medium of claim 11, wherein the document is a document associated with development of a software system.

15. The at least one computer readable medium of claim 11, wherein the act of analyzing further comprises analyzing the document over a period of time.

16. The at least one computer readable medium of claim 11, wherein the act of analyzing further comprises analyzing the document at a regular time interval.

17. The at least one computer readable medium of claim 16, wherein the regular time interval is a daily interval.

18. The at least one computer readable medium of claim 11, wherein the report is a graph.

19. The at least one computer readable medium of claim 11, wherein the act of retrieving the document comprises retrieving the document from a version control software system.

20. The at least one computer readable medium of claim 11, wherein the document was created from a document template.
